(19) United States
(12) Patent Application Publication
(10) Pub. No.: US 2005/0102638 A1
(43) Pub. Date: May 12, 2005

(54) Navigate, click and drag images in mobile applications

(76) Inventors: Zhaowei Charlie Jiang, San Jose, CA (US); Joy Sato, San Jose, CA (US); Jonathan Charles Grubb, San Francisco, CA (US); Yingquing Lawrence Cui, San Jose, CA (US)

Correspondence Address: DECHERT LLP, P.O. BOX 10004, PALO ALTO, CA, 94303, US

(21) Appl. No.: 10/970,862

(22) Filed: Oct. 22, 2004

Related U.S. Application Data
(60) Provisional application No. 60/518,898, filed on Nov. 10, 2003.
(60) Provisional application No. 60/518,858, filed on Nov. 10, 2003.
(60) Provisional application No. 60/518,857, filed on Nov. 10, 2003.
(60) Provisional application No. 60/518,897, filed on Nov. 10, 2003.

(51) Int. Cl. G06F 3/00; G11B 27/00

(52) U.S. Cl. 715/855; 715/721; 715/772; 715/776

(57) ABSTRACT

The need for minimizing the impact of image movement on the memory bandwidth consumption in a mobile device is addressed, in part, by the proposed approach to image movement. The approach for moving an image in a mobile device involves maintaining place holders and a selected holder in the memory of the mobile device. The approach further involves attributing indicia to the image, assigning the indicia of the image to one of the place holders, maintaining a selected holder in the memory, selecting the image and saving in the selected holder the screen location associated with the place holder to which indicia of the selected image is assigned. To move the selected image, the additionally involves reassigning the indicia of the selected image to a different one of the place holders and replacing in the selected holder the saved screen location associated with the place holder with the screen location associated with the different place holder. Memory bandwidth consumption is lower with the use of the place holders and the selected holder than it would be with only movement of the selected image.

### REFERENCE TO PRIOR APPLICATIONS

This application claims the benefit of and incorporates by reference U.S. Provisional Application No. 60/518,898 entitled “Back Button in Mobile Application,” U.S. Provisional Application No. 60/518,858, entitled “Navigation Pattern on a directory Tree,” U.S. Provisional Application No. 60/518,857, entitled “Backup and Restore in Mobile Applications,” and U.S. Provisional Application No. 60/518,897, entitled “Upload Security Scheme,” all of which were filed Nov. 10, 2003.

### FIELD OF THE INVENTION

The present invention relates generally to wireless mobile devices and more particularly to applications that offer navigate, click and drag capabilities. Among such applications, one type is a mobile photos application.

### BACKGROUND

Mobile-friendly technologies are advanced to provide a rich multimedia environment and enhance the wireless device users' experience. An outcome of this evolution is the manifest closeness between the wireless universe and the Internet domain, as well as the advent of wireless devices with multimedia capabilities. The newest versions of mobile wireless devices such as digital mobile phones, pagers, personal digital assistants (PDAs), handsets, and any other wireless terminals, have multimedia capabilities including the ability to retrieve e-mail, and push and pull information via the Internet. Evidently, developers of pocket personal computers such as the Pocket PC™ are working to adopt the elegance and simplicity of devices such as the Palm Pilot™, and the developers of the Palm Pilot™ are moving towards more features, multimedia and the higher-end processors of the Pocket PC™.

The various configurations of mobile device tend to fit their main purpose. For example, devices focused on wireless email access tend to use the Research In Motion (RIM)™ or Danger™ operating systems while devices whose core functionality is personal information management (PIM) tend to use the Palm-OS™ operating system. In many of the mobile devices, voice and PIM are key features along with e-mail, calendaring and in many instances image viewing, Web browsing and connectivity such as Bluetooth™ and Wi-Fi™ connectivity.

With the advancements in display technology, including better resolution, bit depth, and graphics, the range of mobile device display capabilities continues to expand and increase the usefulness of image viewing and Web browsing. Image viewing and Web browsing are important features of mobile devices. Such features enable users to access and view information remotely while on the road for, among other things, mobile marketing, remote presentations, process monitoring, on-location image capturing and delivery, and more. However, even the advanced display capabilities of mobile devices lack certain user interface features.

### SUMMARY

Indeed, even with the limited memory capacity of mobile devices there are ways to improve the range of image viewing and web browsing capabilities with minimal impact on the memory bandwidth consumption. In one instance, user interface with the ability to arrange images on the mobile display adds to the usefulness of mobile devices.

Thus, the invention provides ways for manipulating (moving and rearranging) images on the mobile display. In essence, the navigation key (up-down-left-right arrows) is used to navigate to the desired image. The ‘OK’ button is used to activate the drag (move-rearrange) feature with respect to the desired image. The arrows are additionally used, once the drag feature is activated, to rearranged the images (moving the desired image by swapping its location with that of another image). Finally, the ‘OK’ button is again used, once the desired image has been moved, to fix the location of this image at its current location. Otherwise, until the ‘OK’ key has been pressed, activating the navigation key would keep moving the desired image around the screen. The approach presented here provides for easier navigation between and arrangement of images on the mobile display with little or no additional burden on the limited resources of mobile devices. Specifically, the navigate, click and drag concept is implemented in mobile applications so as to increases their usefulness despite the limited memory capacity of mobile devices. In one example, the Yahoo! Photos application includes the navigate, click and drag feature for manipulating and arranging images on mobile display.

For the purpose of this invention, as embodied and broadly described herein, a method and a system are proposed as possible implementations of the backup and restore concept. These implementations typically involve a server in communication link with a plurality of mobile devices. In the context of the Yahoo! Photos application, the mobile devices are typically wireless devices such as wireless camera phones and the memory items includes photograph data (or simply one or more photos).

In one embodiment, a method for providing the image movement by navigation click and drag includes maintaining place holders and a selected holder in the memory of the mobile device. The method further includes attributing indicia to the image, assigning the indicia of the image to one of the place holders, maintaining a selected holder in the memory, selecting the image and saving in the selected holder the screen location associated with the place holder to which indicia of the selected image is assigned. To move the selected image, the method additionally includes reassigning the indicia of the selected image to a different one of the place holders and replacing in the selected holder the saved screen location associated with the place holder with the screen location associated with the different place holder. Memory bandwidth consumption is lower with the use of the place holders and the selected holder than it would be with only movement of the selected image.

In one implementation, the mobile device is a wireless device such as a wireless camera phone. The mobile device uses the method above as part of a mobile application one example of which is Yahoo! photos. The mobile device includes system components, including memory and processor, to facilitate the image movement as described above. The memory, in addition to the place holders and selected holder, embodies a computer program with code to cause the processor to perform the method as described above.

As can be understood from these examples, by introducing the navigation click and drag capability to the system, the present invention makes the user interface more useful and reacting more responsively. Such advantages will be appreciated by those of ordinary skill in the art from the description and practice of the invention disclosed herein.

### BRIEF DESCRIPTION OF THE DRAWINGS

The accompanying drawings, which are incorporated in and constitute a part of this specification, illustrate embodiments of the invention and together with the description serve to explain the principles of the invention. Wherever convenient, same or similar numbers or designations are used throughout the drawings to refer to the same or like elements.

FIG. 1 shows a wireless interconnection model using one of the many types of available bearer networks.

FIG. 1A shows another model of interaction, via bearer networks, between 3^{rd}-generation (3G)-enabled mobile devices and servers as well as other devices.

FIG. 2A shows a mobile phone with features suitable for the purpose of the present invention.

FIG. 2B, illustrates a particular example of user interface in the context of the Yahoo! Photos application as it relates to the present invention.

FIG. 3 illustrates the PC-based and mobile device-based purchase and sign-in process from the Yahoo! Photos landing page.

FIGS. 4A-4D show the page navigation patterns (screen flows) in the context of Yahoo! Photos.

FIGS. 5A-5D illustrate the navigate, click and drag features and implementation details.

FIG. 6 provides a simplified diagram to illustrate the back button feature.

### DETAILED DESCRIPTION OF THE INVENTION

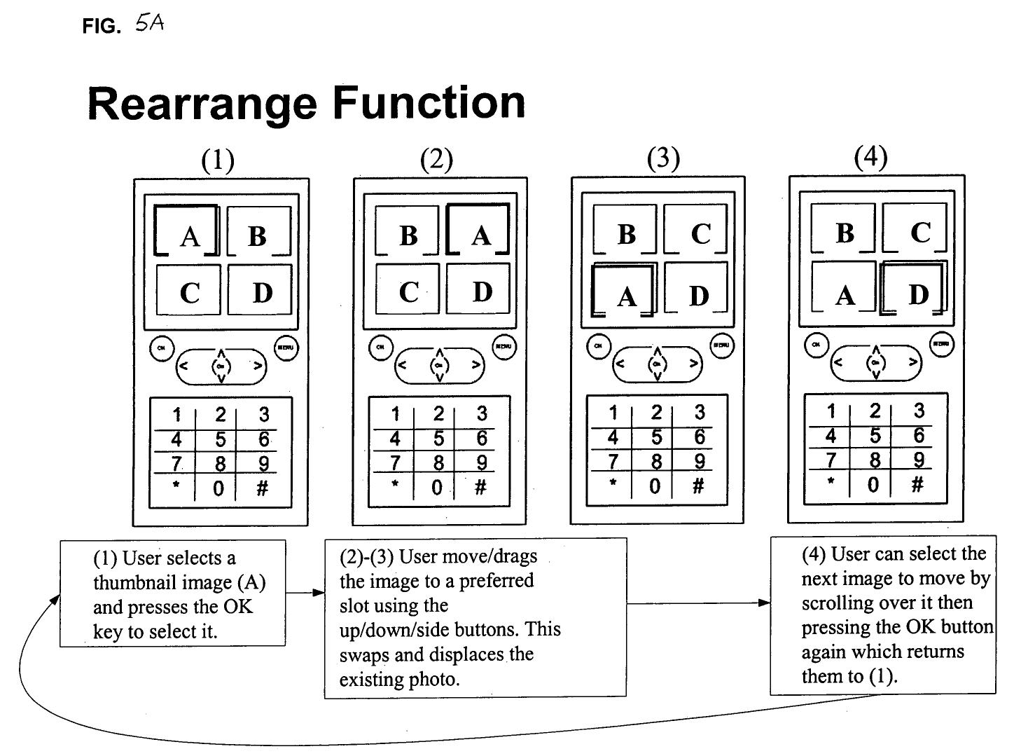

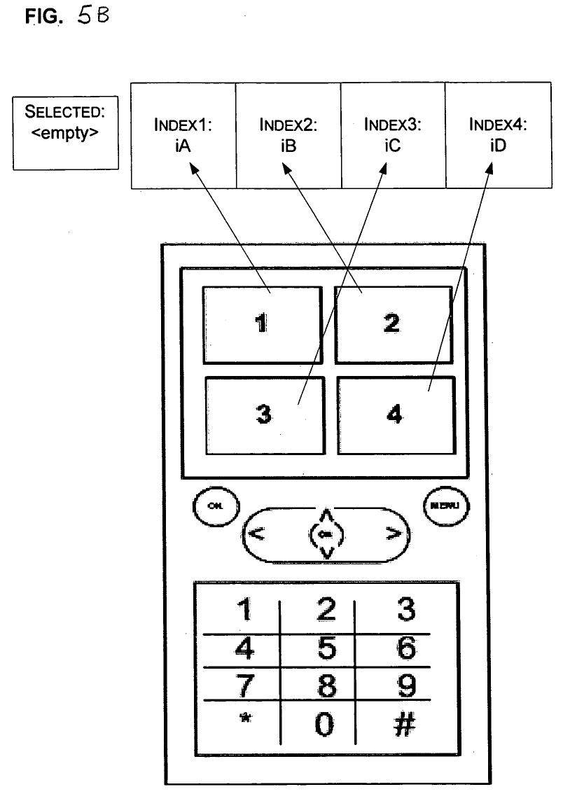

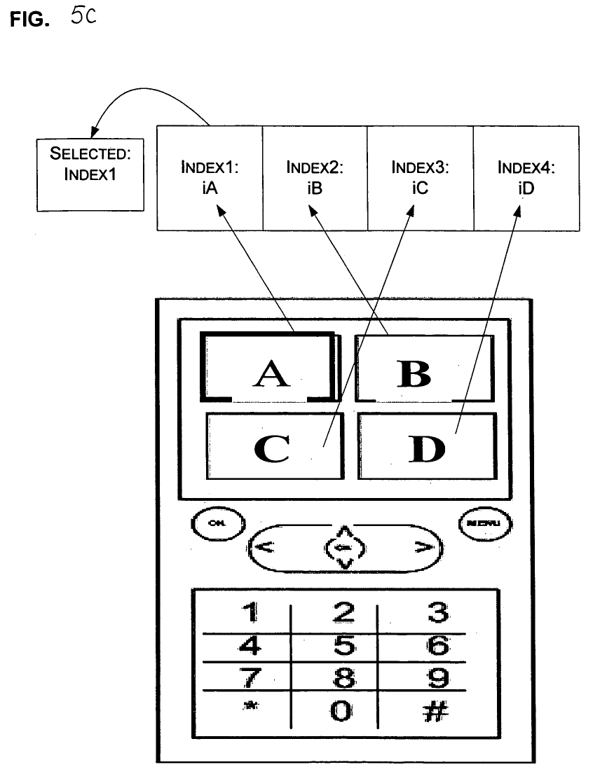

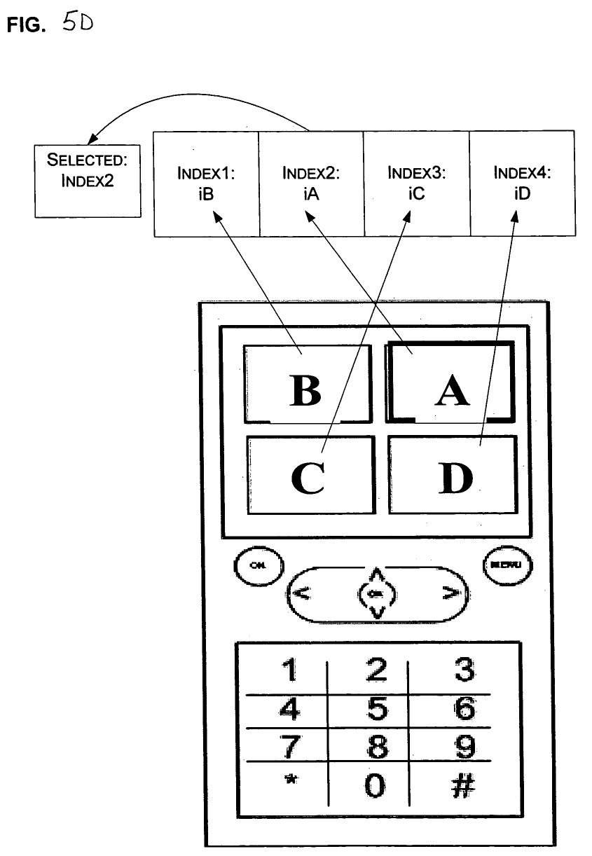

The present invention contemplates navigate click and drag and the implementation of this concept in mobile applications, as illustrated in FIGS. 5A-5D and discussed in more detail in conjunction with these Figures. One such application is mobile photos, an example of which is referred to as the Yahoo! Photos™ application. Yahoo!™ and Yahoo! Photos™ are trademarks of Yahoo! Inc., Sunnyvale, Calif. Any other trademarks are the property of their respective holders.

Although it can be implemented in various applications, for clarity and for illustration, the approach contemplated by the present invention is described here in the context of the Yahoo! Photos application. The server side of this application is the “server Yahoo! Photos,” and the client side of this application is the mobile client application, or “client Yahoo! Photos.” A client application is generally considered to be a downloadable application; namely, J2ME™ (Java™ 2 platform, Micro Edition, by Sun Microsystems, Inc.), Yahoo! Photos™, or any other application that is downloadable to the mobile device. In the example here, the client Yahoo! Photos runs on a mobile phone, and more specifically, a mobile camera phone.

The Wireless Communication Environment

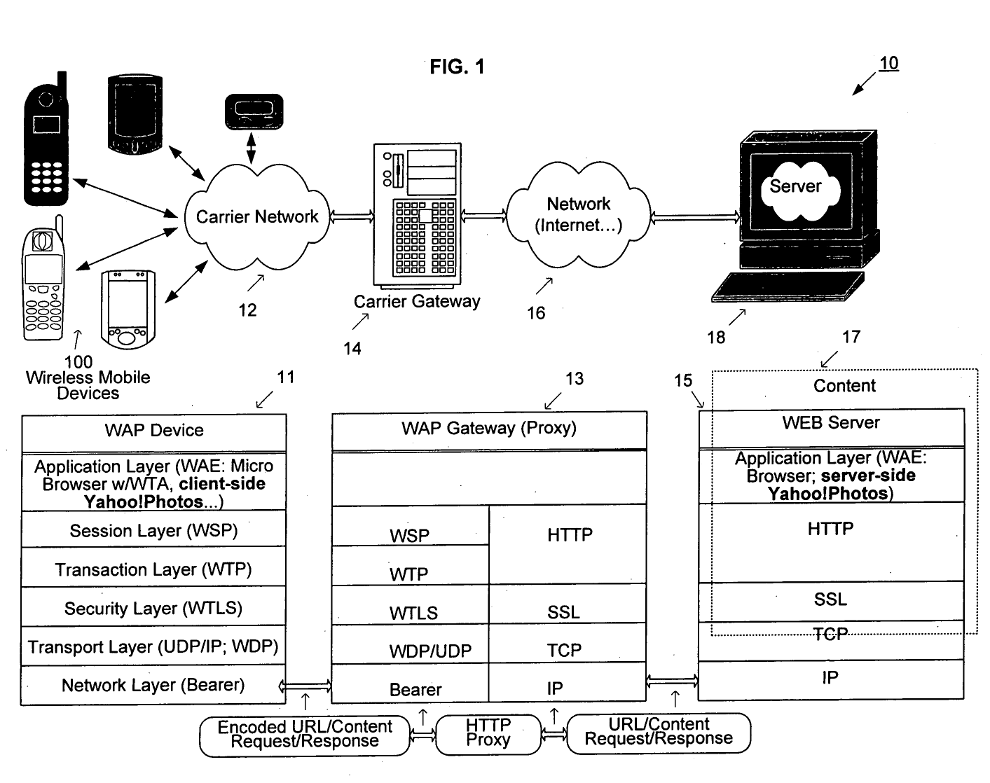

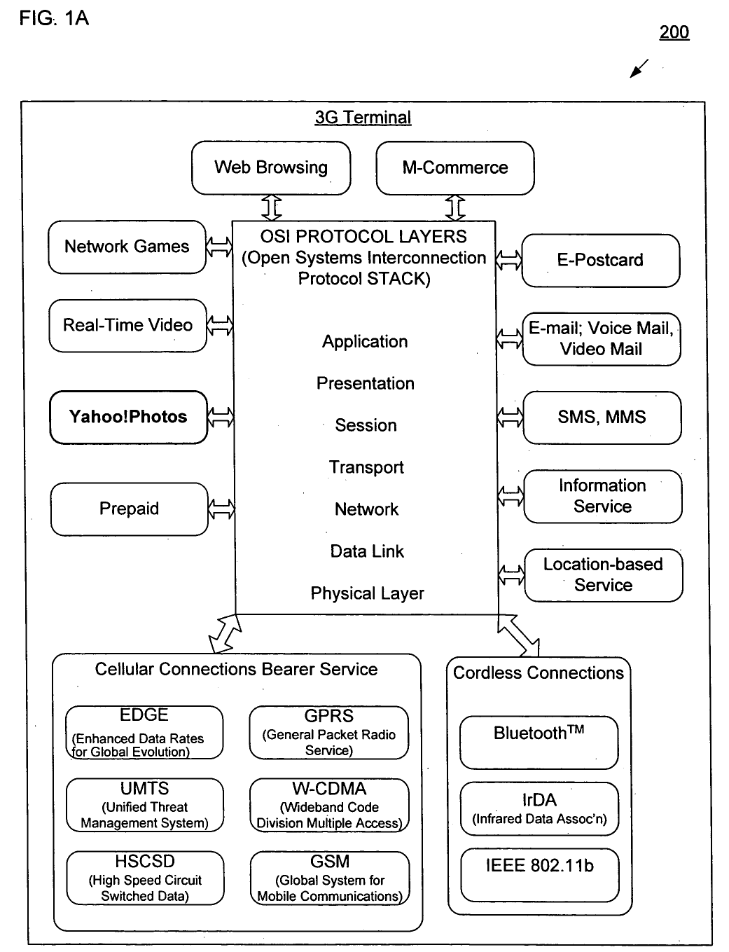

FIG. 1 shows a wireless interconnection model 10 using one of the many types of available bearer networks 12. The illustrated wireless mobile devices 100 are presumed to have sufficient local memory and Internet access capability to allow a user to download programs from servers 18 through the Internet 16 (and any other network such as LAN, WAN or Ethernet network) and store them in the local memory. Thus, wireless subscribers can gain fast access to content in these or other servers via the Internet through various downloadable applications. Note that the illustrated server 18 can be the origin of downloadable programs as well as the origin, or destination, of content; although programs and content can originate at or be destined for different servers. For the purpose of this illustration, the web server 18 is the source of the Yahoo! Photos client side application as well as the source, and destination, of content, particularly photos (image data). Using the downloaded program, such as Yahoo! Photos, and with multimedia capabilities, including the ability to retrieve e-mail, and push and pull information via the Internet, network operators (or, more generally, service providers) add value propositions beyond voice or text offerings.

Indeed, with this capability, users can capture photo images in their mobile devices, store and manipulate the captured images, and upload data of the captured images to a server (e.g., server 18). Thus, the server 18 operates as a repository for the data of photo images, and users can download from the server to their mobile devices data of previously captured photo images, as well as store and manipulate such images. Photos resident on one mobile device can be shared with another via the server 18 and the communication network(s) 12 and 16.

In this wireless interconnect model, the mobile phones used to download the Yahoo! Photos client side program are WAP-enabled (WAP stands for Wireless Application Protocol). As shown in FIG. 1, the WAP-enabled devices 100 support the WAP protocol and the server 18 typically supports the WWW (world-wide web) protocol. In particular, the wireless application environment at the mobile device side 11 includes the micro-browser, a suite of WAP protocols at the network through session layers, and the downloadable (client-side) Yahoo! Photos application program. The micro-browser defines how WML (wireless markup language) documents and WML script applets should be interpreted and presented to the mobile device user. The Micro-browser's WTA (wireless telephone application) functionality provides call control, phone book access and messaging within WML script applets to allow selective call forwarding or other secure telephony. The wireless application environment at the server side 13 includes the server-side Yahoo! Photos in addition to a standard web browser and WWW protocol stack (HTTP and TCP/IP, respectively, hypertext transfer protocol and transmission control protocol/Internet protocol).

To enable web-based access to content, service providers deploy wireless data through the carrier network 12 while controlling the data communications to their subscribers and tracking the billable activity. Typically, the gateway 14 is tasked with tracking subscriber activities, controlling access and, in addition, functioning as the proxy for the mobile device 100, on the one hand, and for the server 18, on the other hand. The gateway 14 is implemented, building on standard web proxy technology, to interconnect the services offered by the wireless service providers to the HTTP protocol so as to permit access to content on the wired Internet.

One model of interaction between a WAP-enabled device, the WAP-enabled proxy/gateway, and the server, is the HTTP 1.1 response/request transaction, where HTTP 1.1 is profiled for the wireless environment. The gateway (13 & 14) translates requests from the WAP protocol to the WWW protocol, and vice versa; translating WML(/HTML) documents to HTML(/WML), resolving domain names in URLs and providing a control point for managing access. From the WAP-enabled gateway with encoders/decoders, the URL requests or WML documents (possibly in encoded form) can be sent encoded/decoded to add security to the user interaction. Note that, unlike the flat structure of HTML documents, WML documents are divided into a set of user interaction units, namely a deck of cards. Each user interaction unit is a card (or page), and the user can navigate between cards in one or more WML documents.

Another model of interaction between a WAP-enabled device, the WAP-enabled proxy/gateway, and the server, is the HTTP response/request transaction (protocol running on top of the Internet's TCP/IP suite of protocols). This model is appropriate for the newer WAP 2.0 (with protocol stack not shown in FIG. 1). Unlike the WAP stack 11, the WAP 2.0 stack includes the IP, TCP (transmission control protocol), TLS, HTTP and WAE layers atop the network layer (all of which are profiled for wireless environment). For example, the wireless profile for the TLS protocol will permit interoperability for secure transactions.

Yet another model of interaction via bearer networks, between 3^{rd}-generation (3G)-enabled mobile devices and servers or other devices, is shown in FIG. 1A. As shown, a 3G terminal supports higher-speed, wider-band wireless cellular service communications based on various technologies, including wide code division multiple access (W-CDMA), general packet radio service (GPRS), global system for mobile communications (GSM), enhanced data rates for global evolution (EDGE), unified threat management system (UMTS), and high speed circuit switched data (HSCSD). A 3G terminal is equipped with cordless connections for local, short distance communications. The communication protocols in the 3G terminal are comparable to the open system interconnection (OSI) protocols, layered in the OSI stack.

Various services are supported by these protocols, including web browsing, short message service (SMS), multimedia messaging service (MMS), e-mail, M-commerce, real-time video, and pre-paid. The MMS, for example, is a store and forward messaging service capable of adding multimedia elements to SMS, including images, text, audio clips, and video clips. MMS is synchronized across a common timeline, rather than being discrete like e-mail and SMS; it is akin to a presentation layer over e-mail and looking like a slide show with images. On a compatible phone, the MMS message will appear with a new message alert. The picture message will open on the screen, the text will appear below the image and the sound will begin to play automatically.

Downloadable applications such as Yahoo! Photos and network games are likewise supported in the 3G terminal and interact with services such as MMS. The originator can easily create a multimedia message, either using a built-in or accessory camera, or can use images and sounds stored previously in the phone (and possibly downloaded from a web site). However, for simplicity, the following description assumes that the mobile device is a WAP-enabled camera phone used for downloading photo applications such as the Yahoo! Photos.

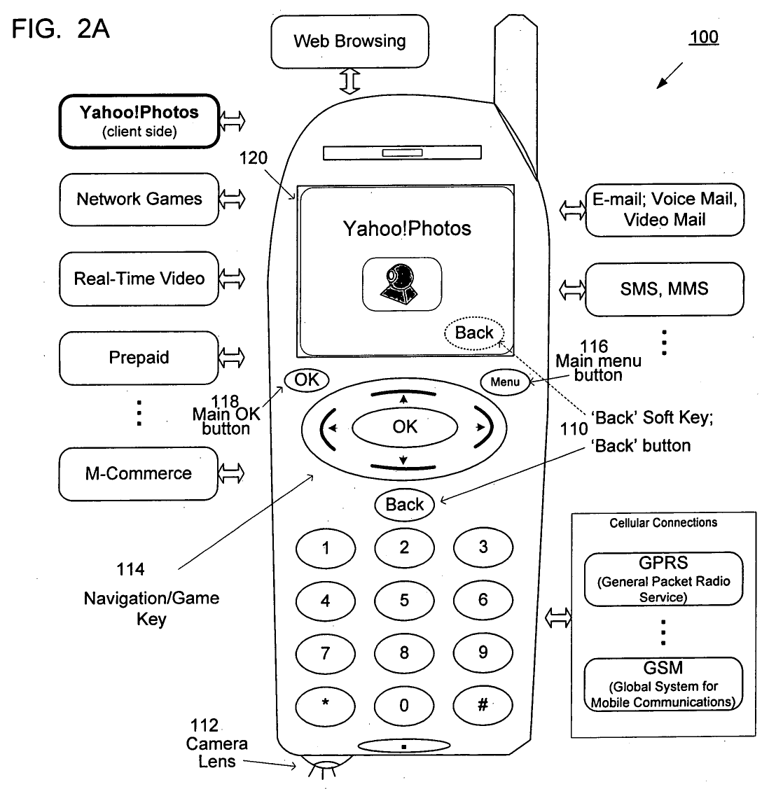

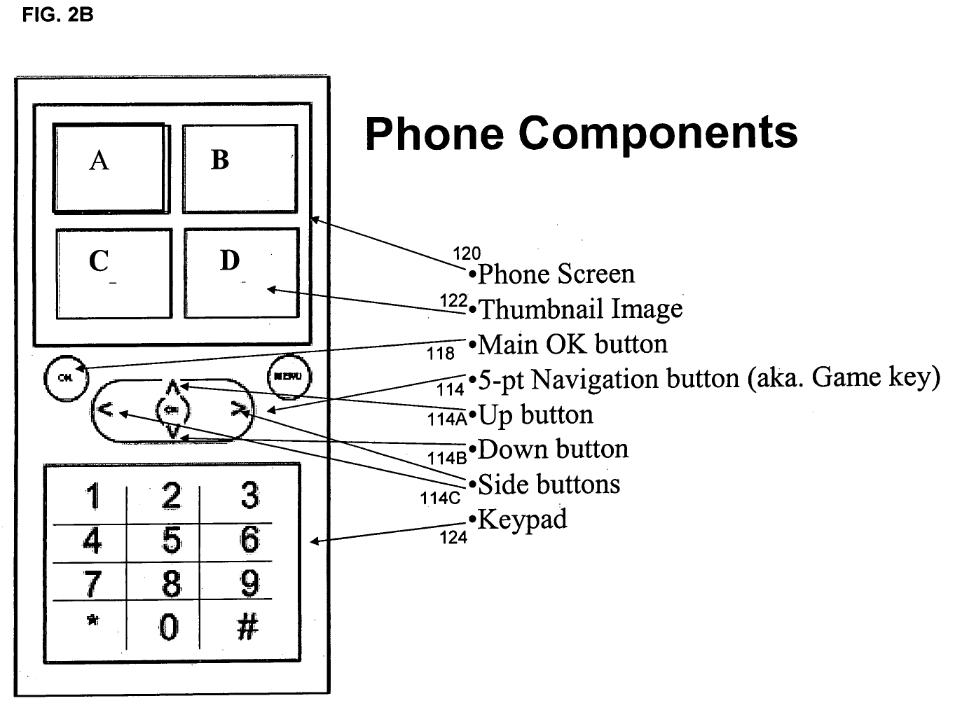

FIG. 2A shows a mobile phone 100, not necessarily associated with any particular manufacturer, but with features suitable for the purpose of the present invention. For example, to accommodate the Yahoo! Photos application, the mobile phone 100 has a camera feature with the camera lens 112 exposed for capturing images. The mobile phone 100 also has a 5-point navigation key (also called game key) 114, and it features left, right, up, down and selection, or ‘OK,’ functions, substantially mimicking the operations of a mouse. The main menu button 116 activates the menu display on the screen 120, and the main OK button 118 activates a menu selection. The ‘back’ button 110 is shown as a hardware key whose position here is merely exemplary. Namely, the physical placement of the ‘back’ button is device dependent, where it is anticipated that buttons on different devices may be arranged differently. A ‘back’ soft-key is possible to implement a ‘back’ function of the WAP browser, which means that it would show up as an icon or menu item on the screen of the mobile phone.

As further shown in FIG. 2A, the Yahoo!-enabled phone 100 supports wireless cellular service communications based on various technologies such as the GPRS and GSM. This device is configured for supporting WAP communication protocols (at all layers of the WAP stack). Various services shown as being supported by these protocols, include web browsing, SMS, MMS, e-mail, M-commerce, real-time video, and pre-paid. The downloadable programs shown to interact with such services include the network games and Yahoo! Photos.

It should be mentioned that, although the manufacturer provides the Yahoo!-enabled phone 100 with camera functionality—i.e., functionality for capturing images, and saving, displaying, manipulating, transmitting and receiving data of images—this camera functionality is independent from the Yahoo! Photos program. That is, data of the captured images resides in the mobile phone outside the Yahoo! Photos environment until such time that this data is introduced to the Yahoo! Photos environment by being first uploaded to the Yahoo! server and then downloaded to the local (mobile) Yahoo! Photos album, as will be later explained.

Note also that the example here focuses on the camera phone, but the principles of the present invention are not limited to camera phones. Any phone or other wireless mobile device can embody a variation of the present invention. When the mobile device is a smart handset, downloading application programs and implementing the navigate click and drag scheme are possible even though the communications with the service provider may be different in character.

The mobile device functionality is preferably implemented using a platform, such as the J2ME™ platform, which is tailored for a broad range of embedded devices including mobile phones. The J2ME™ platform includes a set of standard Java APIs (application programming Interface), and provides a user interface, a security model, built-in network protocols (e.g., WAP, as shown in FIG. 1), and support for networked and disconnected applications (Yahoo! Photos is a networked application).

With the J2ME™ platform, applications are written once for a wide range of device. Applications leveraging each device's native capabilities are then downloaded dynamically. The J2ME™ platform defines configurations, profiles and optional packages as elements for building complete Java run time environments. Configurations are composed of a virtual machine and a minimal set of class libraries and provide the base functionality for a particular range of devices that share similar characteristics. Current configurations include connected limited device configuration (CLDC) for devices with limited memory and processing capabilities (e.g., mobile phones, two-way pagers, and PDAs) and connected device configuration (CDC) for devices with better memory, processing and network bandwidth capabilities (e.g., TV set-top boxes, residential gateways, in-vehicle telematics systems, and hi-end PDAs). However, in order to provide a complete runtime environment targeted at specific device categories, the configurations must be combined with a set of the high-level APIs, or profiles, that further define the application life cycle model, access to device-specific properties, and user interface.

One example of profiles is the mobile information device profile (MIDP) which is designed for mobile phones and entry-level PDAs. MIDP offers a core application functionality required by mobile applications, including user interface, network connectivity, local data storage, and application management. The J2ME™ can be further extended by combining various optional packages and their corresponding profiles to address specific market requirements, e.g., Bluetooth™, web services, wireless messaging, multimedia, and database connectivity.

FIG. 2B illustrates a particular example of user interface in the context of Yahoo! Photos. The image screen is used for image viewing, web browsing and other information management functions. In this particular example, the screen displays four thumbnail images, A, B, C and D. The 5-point navigation key 114, facilitates navigation between the thumbnail images with the up, down, left and right (side) buttons (114A-C). The 5-point navigation key 114 facilitates also the dragging, arranging and re-arranging on the screen of selected thumbnail images. The buttons (114A-C) control the movement (dragging) of the thumbnail images to the left, right, up or down. The ‘OK’ key 118 effects selection and highlighting of a selected thumbnail image and fixing its location on the screen (after the selected image is dragged to its final destination). Specifically, the navigation key (up-down-left-right arrows) is used to navigate to the desired image. The ‘OK’ button is used to activate the drag (move-rearrange) feature with respect to the desired image. The arrows are additionally used, once the drag feature is activated, to rearranged the images (moving the desired image by swapping its location with that of another image). Finally, the ‘OK’ button is again used, once the images has been moved, to fix the location of the desired image at its current location. Otherwise, until the ‘OK’ key has been pressed, activating the navigation key would keep moving the desired image around the screen. Further description on how the navigate, click and drag function operates in a mobile application environment is provided below in conjunction with the detailed description of the Yahoo! Photos application.

Navigate Click and Drag in the Context of Mobile Yahoo! Photos

Before describing its relevant features, we first discuss how the Yahoo! Photos program is obtained and run by the mobile device. On mobile devices, various client application programs are offered to the user on a default start-up or main menu screen or on a manufacturer-installed virtual vending machine screen (vending machines for client (J2ME) applications are the digital rights management systems of the carriers designed to manage the ownership or licensing of applications from the carrier on behalf of the application developer/distributor to be purchased by the consumer). Other selection items include, for example, the menu item for setting the sound. These start up and vending screens show a menu with a list (or icons) of applications which the user can obtain by following an install procedure. The menu provides links to various service web sites, including, for example, the Yahoo! Photos site. The links, of course, are URLs (Uniform Resource Locator)—i.e., the world wide web address of a site on the Internet, and on the Yahoo!-enabled phone, at least one such menu item is the link for downloading the Yahoo! Photos application.

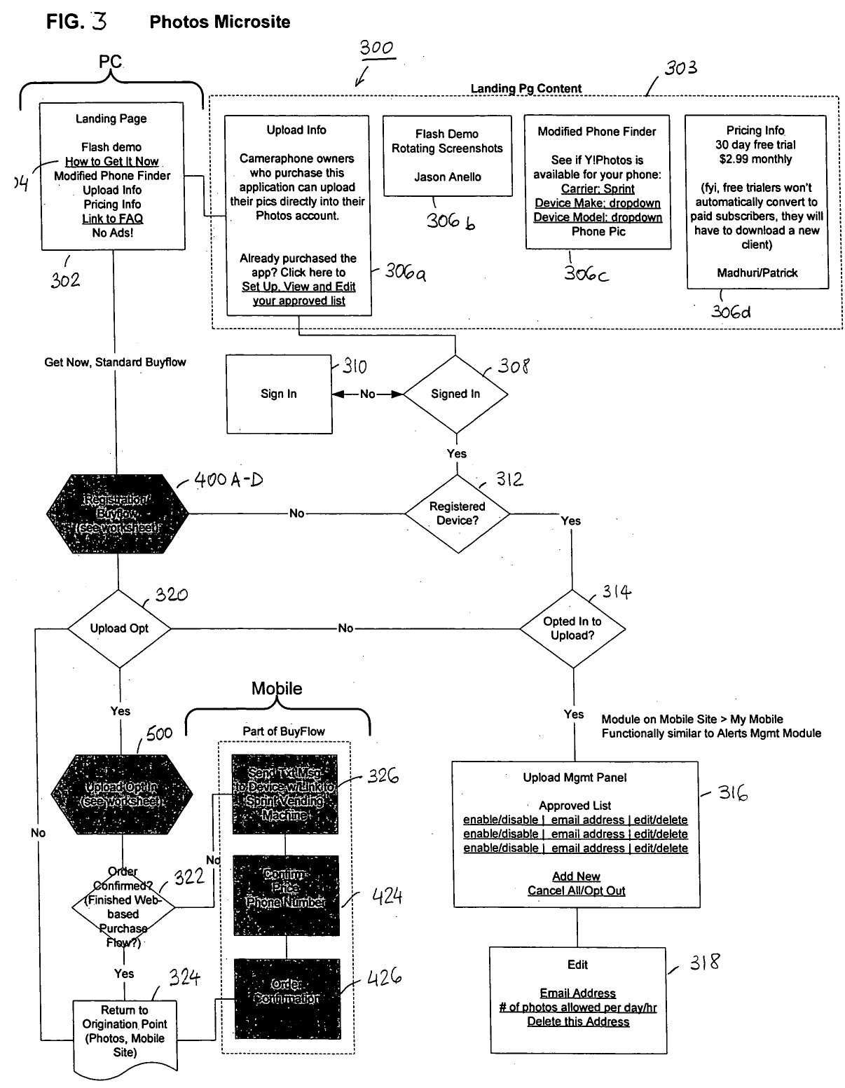

FIG. 3 illustrates the flow once users reach the mobile application site, which, in this example, is the Yahoo! Photos landing page. The URL for the landing page is obtained via a link from a promotional web page, through a web search, or from a bookmark (or favorites). The flow is shown as originating on a user's PC (personal computer) and it commences with program information presented at the landing page 302 on the PC display. The contents 303 and 304 of the landing page is presented to show the options available to the user based on whether or not the user has already purchased the Yahoo! Photos program. For instance, the landing page presents to the user the Yahoo! Photos program name with the option of “how to get it now” 304, as well as upload information 306a, flash demo 306b, and pricing information 306d, say, “$2.99 monthly.” To buy the application the user clicks on the application name, Yahoo! Photos, or on “how to get it now.” Subsequent to the registration 400_{A-D}, a query (such as “would you like to buy it for $2.99?”) prompts the user to accept/reject the offer 320. Then, for the purpose of implementing upload security, the user is prompted to establish upload opt-in parameters 500, as will be later explained.

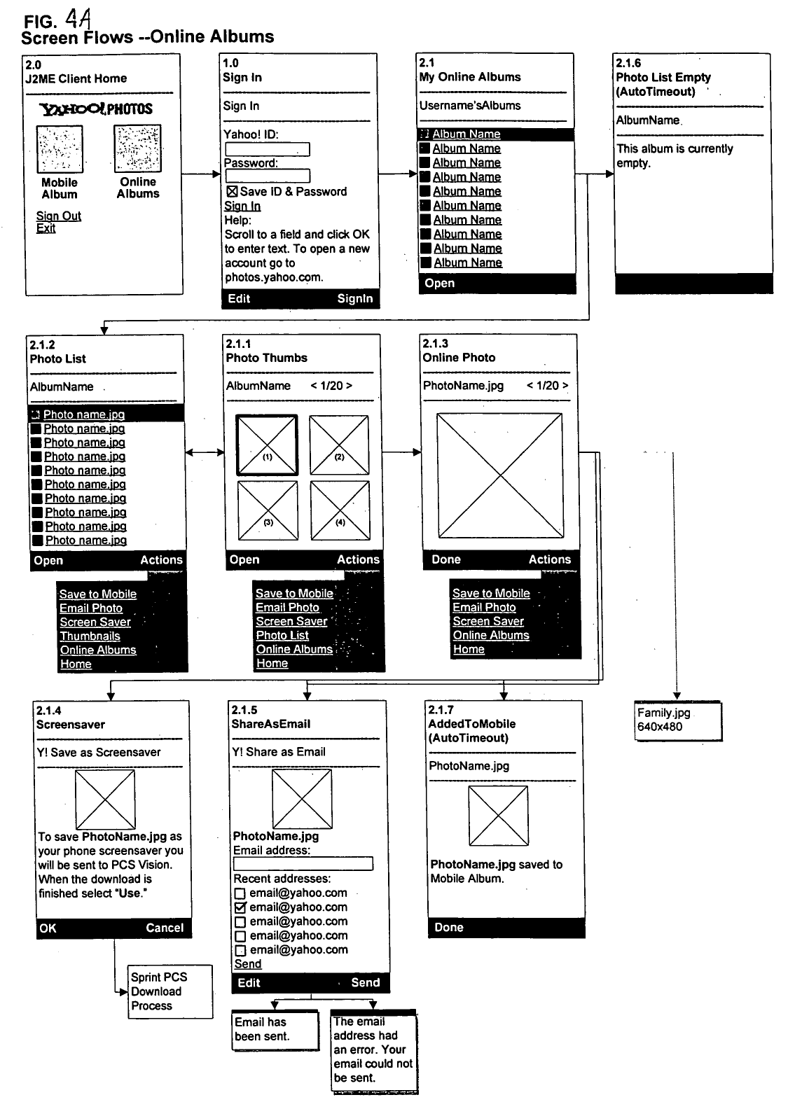

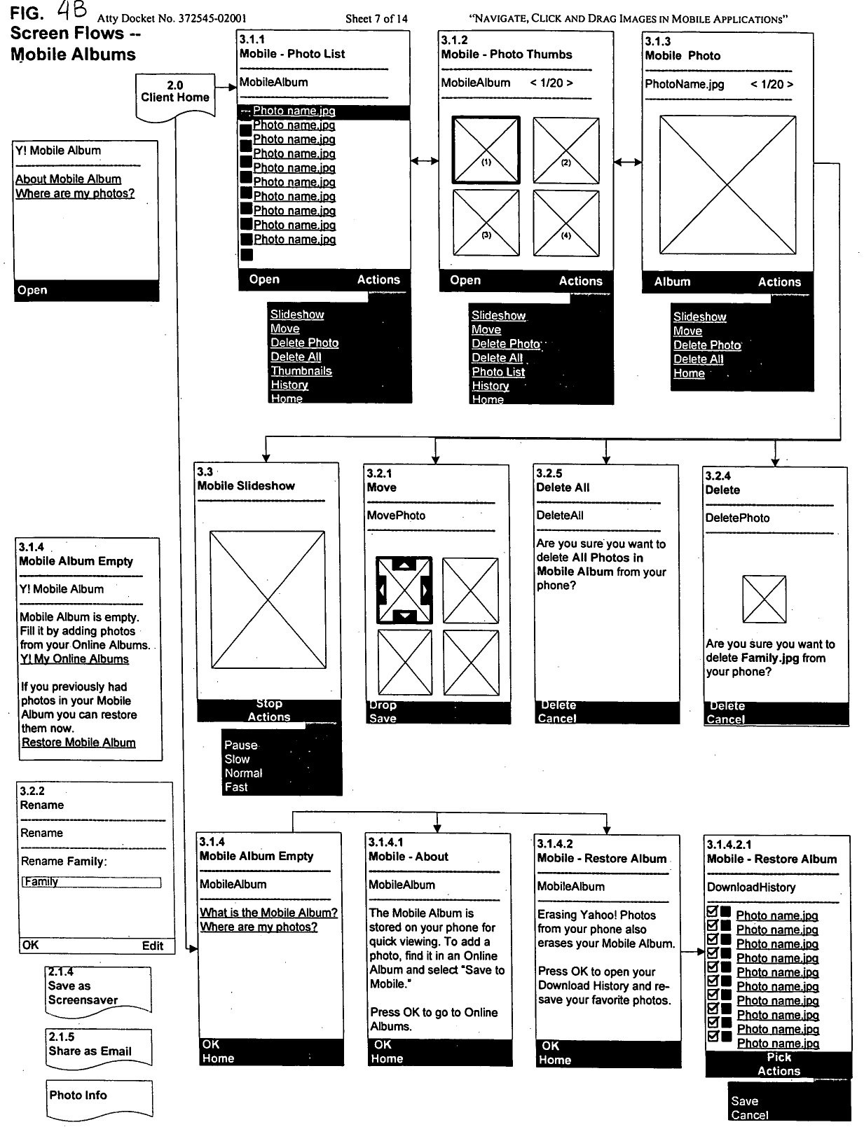

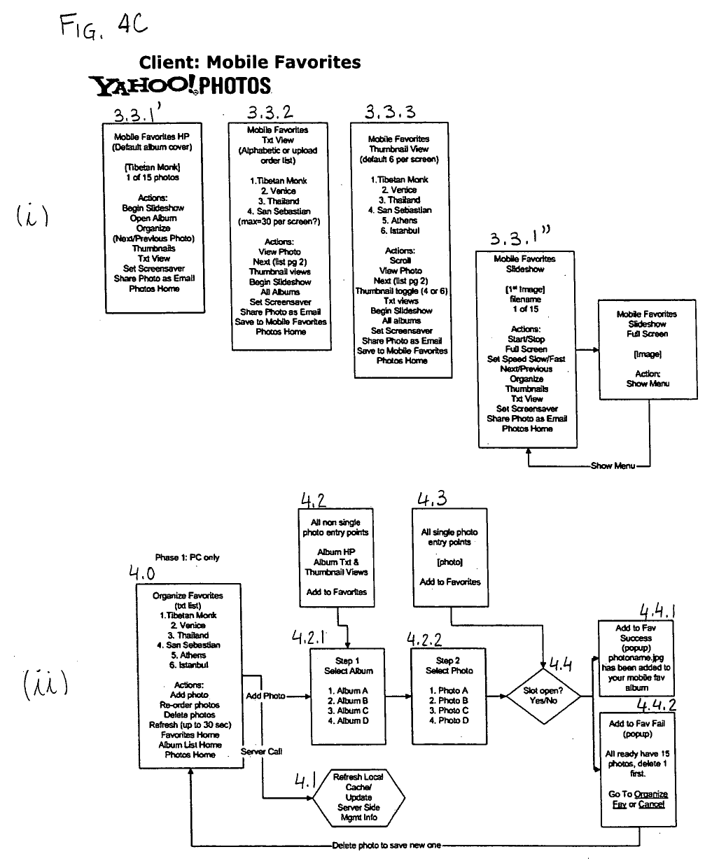

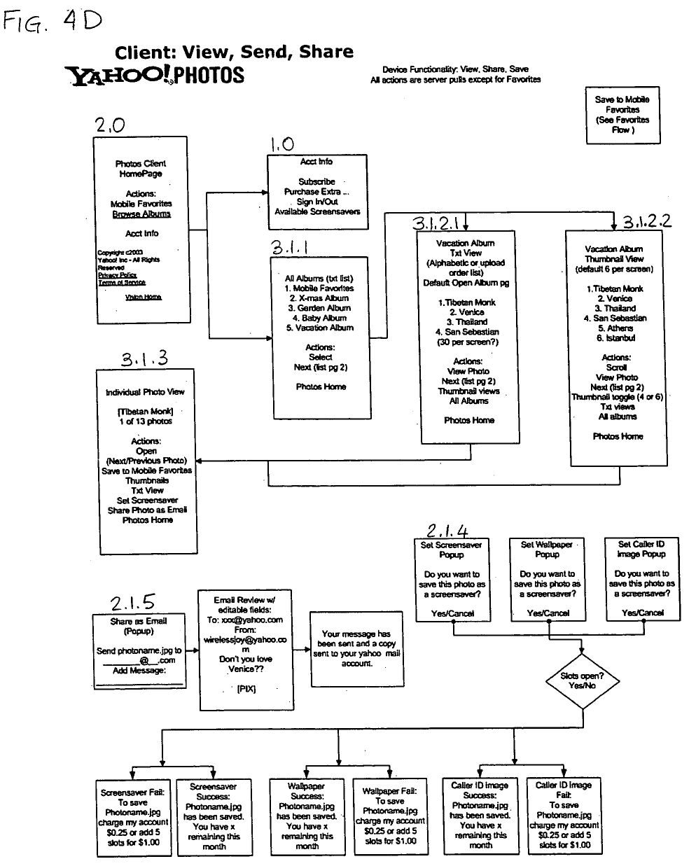

If the user accepts the offer to buy the application, the order is confirmed 322 and the application is downloaded into the mobile phone, becoming resident on the mobile phone. Once the Yahoo! Photos program is resident on the mobile phone it can be invoked from the landing page or menu page (using the menu button on the phone to bring up the menu or using the default menu if Yahoo! Photos is presented as one of the default menu options). Invocation of the Yahoo! Photos application allows, among others, user access and manipulation of the user's mobile album as well as online albums in the user account. FIGS. 4A and 4B show the screen flows for online albums and mobile albums, respectively.

Invocation of Yahoo! Photos prompts this program to display the ‘home’ page 2.0 with two main options: mobile album, and online album (as shown in FIGS. 4A and 4B). The mobile album is an album of photos stored locally on the mobile phone, so that the user need not go out over the network to obtain them. The online album is an album of photos stored on the server in the user's account.

As mentioned before, photo images can be captured and manipulated by the mobile phone outside the Yahoo! Photos environment. These photo images will not be available at the mobile or online albums until they are uploaded to the server and then (selectively or in batch) downloaded from the server. Accordingly, selecting ‘online album’ allows the user to access and manipulate photo images that have already been uploaded to the server from the user's PC or mobile phone and stored in the online album. The online album is dynamically rendered within the client (mobile device) based on the client-server interactions (i.e., photos are pulled from the server dynamically and placed in the online album). It reflects the exact state of the server at the time of the query and requires a live online connection. To save a photo from the online album to the mobile album the user clicks “Save to Mobile Album.” This process takes time, in some instances approximately 10 seconds, depending on the device and network connectivity. Each time this action takes place it is recorded (as backup) by the server.

By analogy, selecting ‘mobile album’ allows the user to access and manipulate photo images that have been already downloaded from the server and saved in the mobile album. If the user saves, for example, 5 photos to the mobile album, the user is then able to view the 5 photos without again accessing the server via the network (wireless and Internet). Viewing these photos in the mobile album is significantly faster than viewing them in the online album because they are native (present locally) instead of being dynamically pulled from the server over the network.

Then, if the ‘online album’ option is selected from the Yahoo! Photos client program ‘home’ page (2.0), as shown in FIG. 4A, it prompts the program to display the next page which is the ‘sign-in’ page (1.0). It requires the user to follow a sign-in procedure that typically includes providing a Yahoo! ID and user password. The sign-in procedure will, among other things, bring up the user's account and relate it to the user's online albums. That is, the sign-in procedure allows the user to access his account via the Internet (and other proprietary network if applicable).

The next page is the ‘my online albums’ page (2.1). For the specific user, this online albums page lists the names of photo albums available to the named user which are associated with the user's account. Of course, the album listing includes only albums that are on the server and can be dynamically pulled from it. If the selected album is empty the next page will display an indication to that effect (i.e., “this album is currently empty” at page; 2.1.6). Alternatively, if the album is not empty, selecting that album will bring up the next page, the ‘photo list’ page for that album (2.1.2). In the ‘photo list’ page, a photo can be selected for downloading it from the server onto the mobile phone. Additionally, a selected photo can be opened or other actions can be invoked in relation to it. The other actions are presented in a menu that is shown on the screen as a pull-down menu, pop-up menu, or a menu superimposed on any part of the current page (in this example the menu is shown as a pull-down menu).

Such menu (hereafter “photo options menu”) provides a number of selection items, each of each representing an action, including: ‘save to mobile,’ ‘email photo,’ ‘screen saver,’ ‘thumbnails,’ ‘online albums,’ and ‘home.’ Each selection brings up a page that corresponds to the selected action item. Two of the action items have already been discussed above, ‘home’ and ‘online album.’ Selecting home, will lead the user back to the home page (2.0), and selecting online album, will lead the user to the aforementioned ‘my online albums’ page (2.1).

Selecting ‘thumbnails’ brings up a ‘photo thumbs’ page 2.1.1 that shows a group of thumbnail photo images from the selected album. Note that the number of photo thumb groups downloaded from the server depends on the memory size of the mobile phone (or whatever device is used). With this feature, the user can then thumbnail through the groups of photos in the album. The groups of thumbnail photo images in this album are each loaded from the server. The user can then move between the images back and forth (scroll back and forth) and select any one of the photos in the ‘thumbnails’ page. A selected thumbnail image will be enlarged in the next page, the ‘online photo’ page (2.1.3). More on the navigation, click and drag will be described later in conjunction with FIGS. 5A-5D.

As can be seen in FIG. 4A, each of the pages, ‘photo list’ (2.1.2), ‘photo thumbs’ (2.1.1), and ‘online photo’ (2.1.3), includes the photo options menu feature. Among these action items, when ‘save to mobile’ is invoked from the ‘photo list’ page, ‘photo thumbs’ page, or ‘online photo’ page, it causes the selected photo image (previously downloaded from the server) to be saved in the mobile album on the mobile phone. The ‘added to mobile’ page (2.1.7) is brought up in this case to show the photo being saved and to give an indication that saving is done.

When ‘email photo’ action is invoked, the ‘share as email’ page comes up (2.1.5). This page shows the photo(s) selected for emailing and prompts the user for the email address. In this implementation, a number of recently-used email addresses are provided. Incidentally, ‘email’ is simply a transport mechanism which is presently used to send photos from camera phones. Other transport mechanisms may be developed and employed for this application. Then, when the photo is emailed from the mobile phone to the selected e-mail address, a message pops up indicating that the email has been sent or, if not, that an error occurred. For example, a transmission will fail if the user is not authorized to upload photos to the selected e-mail. An error message of this kind is a product of the upload security scheme as embodied in the Yahoo! Photos application program.

When the ‘screen saver’ action is invoked, the selected photo will be used to populate the screen when the phone is idle, standing by, or starting up. The ‘screen saver’ option is associated with screen saver page (2.1.4) which shows the selected photo and requires the user to select ‘OK’ or ‘cancel’ to add this photo to the screen saver photo roster. A message pops up to indicate the status of the photo download.

Going back to the mobile album is possible with the photo options menu via the ‘home’ page, using the ‘home’ option as discussed above. Another way for getting to the mobile album or any other previous page is with the “back” action using the ‘back’ button. Also, as mentioned above, when the Yahoo! Photos application is invoked from the landing/menu page, the ‘home’ page (2.0) presents the ‘mobile album’ as one of the selection items. Accordingly, the mobile album can be accessed directly via the ‘home’ page.

The mobile album screen flow, shown in FIG. 4B, starts with the ‘home’ page (2.0) and selection of the mobile album brings up the ‘mobile photo’ list page (3.1.1). This page presents two action menus, ‘open’ and ‘action.’ Thus, selection of any of the listed photos can be followed by selecting ‘open’ or ‘action.’ As before, when ‘open’ is selected the photo is shown on the screen in the ‘photo thumbs’ page (3.1.2). When ‘actions’ is selected, a mobile photo action menu is provided. This menu includes action items such as ‘slide show,’ ‘move,’ ‘delete photo,’ ‘delete all’ (photos), ‘thumbnails,’ ‘history,’ and ‘home.’

Except for the photos being local (at the mobile album), the thumbnails feature, associated with the ‘photo thumbs’ page (3.1.2), works as described above with reference to the online album. A photo selected on the mobile ‘photo thumbs’ page can be enlarged as shown in the next page, the ‘mobile photo’ page (3.1.3). The menu for the ‘photo thumbs’ and ‘mobile photo’ pages includes a subset of the aforementioned mobile photo action menu.

When the slide show is invoked from such a menu the ‘mobile slide show’ page comes up (3.3). While this feature is active, the slide show scrolls through the mobile album photos, showing each photo for a certain period. The slide show goes on until the user selects ‘stop’ on the bottom of the page. If the user selects ‘actions’ a slide show menu gives the user the options of ‘pause,’ ‘show,’ ‘normal,’ and ‘fast.’ The ‘pause’ option is selected for pausing the slide show; ‘slow’ will slow down the slide show, ‘speed’ will speed up the slide show, and ‘normal’ will bring it to normal speed. (FIG. 4C, parts (i) and (ii), describes setting up favorites for the mobile album slideshow; part (i) describes the process in the mobile device, and part (ii) describes the process originating at the PC).

As further shown in FIG. 4B, the ‘move’ page comes up (3.2.1) when the ‘move’ action (referred to also as ‘rearrange’ action) is selected from any one of the three pages (3.1.1, 3.1.2 and 3.1.3). In this page, the program displays a group of photos (thumbnails) and the user can rearrange the photos using the 5-point navigation key, as well as choose to drop a photo or save it (FIG. 4D shows flow diagrams for photos view, share and save). When the ‘delete’ or ‘delete all’ actions are selected, the user has the option of deleting or canceling the delete action (as shown in pages 3.2.5 and 3.2.4). The ‘delete’ page shows the photo selected for deletion to allow the user to change their mind. When all the photos are deleted, or when the mobile album is empty to begin with, the ‘mobile album empty’ page is displayed (3.1.4). It allows the user to select the home page or select the answer to any one of the queries, such as “where are my photos?” and “what is the mobile album?.” Selection of the latter will bring up the ‘about’ page (3.1.4.1), and in this page pressing ‘OK’ provides user access to the online album(s). Selection of the former brings up the ‘restore album’ page 3.1.4.2.

As with the previous page (“where are my photos?” page 3.1.4), the ‘restore album’ page (3.1.4.2) allows the user to go to the ‘home’ page (2.0). This time, via ‘OK’, it allows the user to go to the next mobile ‘restore album’ page (3.1.4.2.1) for a historical photo download list (of photos previously downloaded to the mobile phone).

Note that the pages shown in FIGS. 4A-4D and discussed herein are exemplary rather than exhaustive, and they do not necessarily include all possible pages (or user interaction cards) that a photo application such as Yahoo! Photos presents. Moreover, the reference designations (call-out numbers) typically refer to the pages themselves rather than any portion of their content. Where applicable, similar pages appear in different figures with the same call-out numbers, e.g., home page 2.0, although their respective contents can vary slightly.

From the screen flows and page navigation patterns we turn now to discuss the image navigation, clicking and dragging. The principles of image navigation, i.e., scrolling up-down-left-right between images, and clicking and dragging are illustrated in FIG. 5A and their implementation details are shown in FIGS. 5B-5D.

As shown in FIG. 5A, the mobile device displays four thumbnail images, A, B, C, and D. The thumbnail images are typically available in the photo thumb pages 2.1.1 and 3.1.2 and the move photo page 3.2.1 (FIGS. 4A and 4B). A ‘move’ action for rearranging the images of the screen is performed with the click and drag feature. In this example, we assume that step 1 represents navigation to image A with the 5-point navigation key and selection of image A with a click on the OK button. Using the up-down-right-left buttons (arrow keys) of the navigation key the user then drags image A where, for example, in step 2 the user drags image A to the right and in step 3 the user drags image A to the left and down. When the user drags image A this image displaces whatever second image was present in the location now occupied by image A and the second image occupies the location previously occupied by image A, namely the images swap locations. In step 2, dragging image A to the right results in image A taking the place of image B on the display and image B taking the place of image A on the display. In other words, image A and image B swap locations on the display. In step 3, image A swaps location with image C, such that image A is dragged by the user to the lower left corner of the display and image C is moved by the program to the upper right corner. In step 4 the user can navigate to and select another image, this time image D. After navigating to image D, it is selected when the OK button is activated. It is possible to show which image is being selected by highlighting the image. The drag (move-rearrange) feature is activated when the OK button is activated (e.g., depressed). Then, once the selected image has been moved (dragged) to its desired location, the OK button is again activated to fix the location of the image.

For implementing the foregoing navigate, click and drag feature, one embodiment includes a plurality of place holders, one for each image plus one that is a holder of the location index of a selected image. For the four images in the foregoing example, the program uses five placeholders (4 indices and one selected index holder). As shown in FIG. 5B, the location indices are listed as follows
‘index1’—stores the index of the image in location 1.
‘index2’—stores the index of the image in location 2.
‘index3’—stores the index of the image in location 3.
‘index4’—stores the index of the image in location 4.
   ‘selected’ holds the location index of an image that is currently selected (and is or can be dragged to another location).

Initially, when the program starts running and the display is created, the selected index holder is empty, and we assume that:
image A is associated with image index ‘iA’ and is at location 1;
image B is associated with image index ‘iB’ and is at location 2;
image C is associated with image index ‘iC’ and is at location 3;
image D is associated with image index ‘iD’ and is at location 4.

When a photo thumbs or photo move page is loaded and put on the screen, as shown in FIG. 5B, the place holders are assigned image indices as follows:
index->iA
index2->iB
index3->iC
index4->iD
selected-<empty>.

The place holders for the image indices, e.g., index1-index4, are location indices associated with the location of images on the screen. For example, index1 is associated with the location at the top-left corner and index4 is associated with the location at the bottom-right corner of the screen.

In terms of possible variations in the implementation, the place holders and indices can include a value or a pointer to the value. Also, the use of indices is a mere convenience and not necessarily a limitation on the manner in which the images or their location can be referenced. For example, any indicia to properly reference the images can be used without departing from the scope and spirit of the present invention.

As shown in FIG. 5C, when one of the four thumbnail images is selected, the location index associated with and which identifies the location of the selected image is remembered by the program in the selected index holder. The image is then highlighted by the application. To illustrate this we assume that after reaching image A it is selected for rearrangement. This will result in:
selected->index1
   where the selected index holder now contains the location index for the selected image A. Having been selected, the highlighted image A can then be dragged to any of the possible locations on the screen. To this end, the application is designed to track the movements of image A. In this particular embodiment, the location index saved in the selected index holder is swapped with each move to track movements of the image between locations and the screen is redrawn to show the rearranged images.

As shown in FIG. 5D, image A is dragged to the position formerly occupied by image B. At the same time, image B is moved by the program to the position formerly occupied by image A. After this location swapping, the contents of location indices index1 and index2 and the contents of the select index holder change to reflect the rearranged images. Specifically, following the image rearrangement, the contents of the indices is as follows:
selected->index2
index1->iB
index2->iA
index3->iC
index4->iD
   where the selected index holder includes the new location index (index2) for image A. In other words, the selected index holder continues to track image A as long as image A is selected. The image can be dragged again and each time it moves the foregoing process is repeated. The location of image A is not considered final (fixed) while image A is being dragged, but it is fixed when the OK button is activated. The final values of the index1, index2, index3, index4 are saved so that next time the screen is reloaded, the screen reflects the final arrangement of images on the screen.

It is important to remember that although the navigate, click and drag functionality is described in the context of the Yahoo! Photos program, it is useful in any mobile device application where this type of user interface capability is desired. Thus, although this feature is implemented for the Yahoo! Photos application, it can be implemented more generically for other applications.

Going back to the general overview, in the context of Yahoo! Photos, every photo from the user's online album that is saved to the mobile album is ‘remembered’ by the server. Indeed, any action (for example, the history required for the back in sequence implementation), not just a photos download history, can be recorded as a backup on the server side. Preferably, since the page traversal path is not predictive the history is recorded accurately and fully.

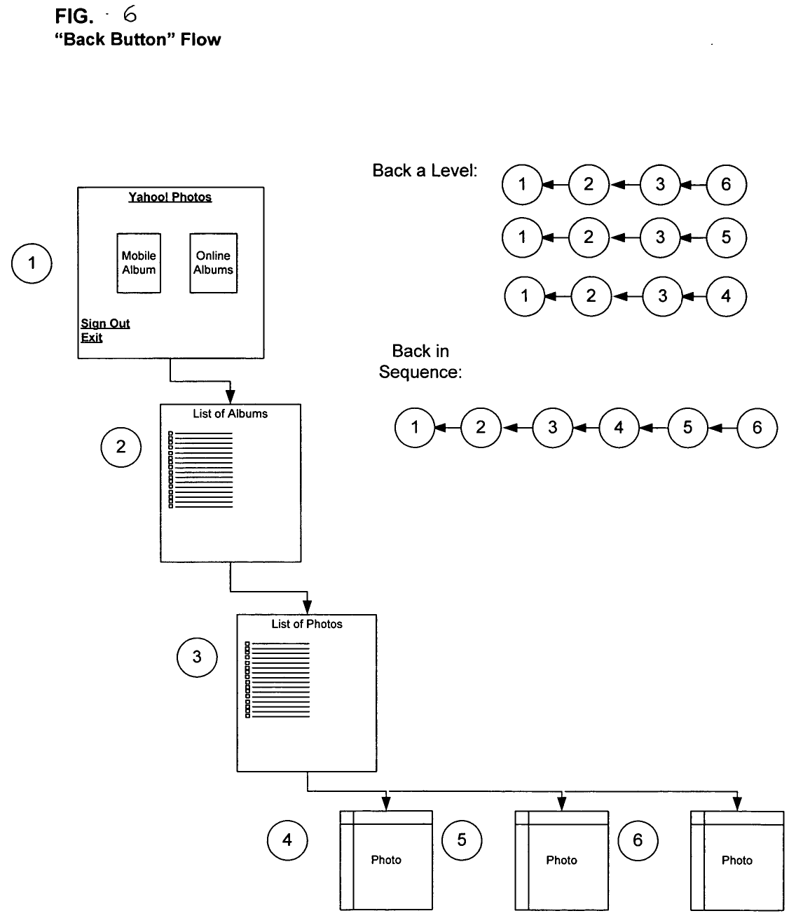

One navigation feature of the Yahoo! Photos that benefits from the aforementioned backup and restore of history records is the back functionality, particularly the back in sequence functionality. As to navigating through the pages on the mobile phone, the pages can be traversed forward as described above and they can be traversed backwards using the “back button” feature. FIG. 6 provides a simplified diagram to illustrate the “back button” feature.

As can be seen, the “back a level” mode allows hierarchical backwards sequence traversal one level each time the ‘back’ button is touch activated or clicked (hereafter “clicked”). The “back in sequence” mode allows sequential backwards one page each time the ‘back’ button is pressed. For example, in back a level mode, back a level takes the application from a photo page (e.g., 6) one level up to the list of photos page (3); and from there one more level up to the list of albums page (2) and one more level up to the home page (1). As can be further seen in this example, the back in sequence mode functions to take the application from the current photo page (6) to the former photo page (5), rather than up one level (3), when the back button is touched. Additional activations of the back button will traverse through all the pages in reverse sequence.

It makes no difference if the “back button” feature is used while in the online album or mobile album part of the application. The principles apply equally well to both situations. Either way, the steps (pages traversed) are remembered, and they can be recorded server side, locally, or both on the server side and locally.

In view of the above, the navigate, click and drag functionality allows image selection and arrangement with relative ease. The implementation details of this functionality as described above are applicable but are not exclusive to Yahoo! Photos. Also, other applications may allow for alternative implementation of navigate, click and drag using the same principles.

Implementation Details

Additional implementation details associated with the foregoing description are provided below. These implementation details include an initial list of devices, soft key mapping, labels, global elements and screen flows tables for the online albums and mobile albums. These details are described in the following pages.

Possible Mobile Devices

The visual and interaction design as described herein should accommodate various types of mobile devices, including, for example, those listed in the table below.

| VENDOR | MODEL | USABLE PIXEL DIMENSIONS |
|---|---|---|
| Audiovox | 8450 | 128 × 112 |
| Samsung | A660 | 128 × 146 (without Soft key) |
| | | 128 × 131 (with Soft key: 15) |
| Sanyo | RL2000 (7200) | 120 × 112 (include soft key) |
| Sanyo | RL2500 (5400) | 132 (W) × 160 (H) including Soft key |
| Sanyo | 5500 | 132 (w) × 160 (h) including Soft key |
| Sony Ericsson | T608 | 128 × 114 pixels |
| Toshiba | 9950 | 261 × 240 |
| Hitachi | SH-P300 | 120 w × 130 h |
| LG | 5350 | 120 × 96 |
| Samsung | A500 | 128 × 146 (without Soft key) |
| | | 128 × 131 (with Soft key: 15) |
| Samsung | N400 | 128 × 114 (without Soft key) |
| | | 128 × 102 (with Soft key: 12) |
| Samsung | A600 | 128 × 146 (without Soft key) |
| | | 128 × 131 (with Soft key: 15) |
| Samsung | VGA 1000 | 128 × 146 (without Soft key) |
| | (A620) | 128 × 131 (with Soft key: 5) |
| Sanyo | 4900 | 120 × 112 includes Soft key |
| Sanyo | 5300 | 132 × 160 (includes soft key) |
| Sanyo | 8100 | 128 × 120 (with soft key) |
| | | 120 × 112 (without Soft key) |

Soft Key Mapping

For the purpose of this invention, the following keys are available on the mobile devices: Up; Down; Left; Right; Select/OK; Left Soft key; Right Soft key; and Back. If a device does not have an obvious select key, it is assumed that the MIDP (mobile information device profile) implementation will automatically provide a select option at one of the soft keys or in one of the soft key menus.

KEY MAPPING

| | |
|---|---|
| Up | Scrolls the cursor up, or selects the previous item in a list. |
| Down | Scrolls the cursor down, or selects the next item in a list. |
| Left | Scrolls the cursor left if possible. |
| Right | Scrolls the cursor right if possible. |
| Select | LINK OR BUTTON: Go to appropriate screen |
| | EXCLUSIVE LIST (Radio buttons): Selects the radio button. |
| | MULTIPLE LIST (Checkboxes): Checks and un-checks the checkboxes. |
| | TEXTBOX: Takes the user to the text editor |
| | TEXT STRING: Does nothing |
| Two Soft keys | Soft key functionality varies greatly among devices. The ordering and |
| | positioning of options can't be controlled with any degree of accuracy; the |
| | order shown indicates only the relative importance of the options. |
| | In the examples presented herein, options are assigned a type (BACK, EXIT, |
| | ITEM) |
| | The following layout is preferred: |
| | Item 1: primary soft key |
| | Item 2: If no others are present, secondary soft key should have item 2 as its |
| | label. If additional items are available they should be listed in priority order in |
| | the menu, which is accessed via the secondary soft key. |
| | Primary soft key should have the same function as the ‘Enter’/‘OK’ key |
| Back | ‘Back’ button links back to previous screen. |
| | Does NOT link one level up in the navigation tree, unless that is the previous |
| | screen. |
| | Does not link back to confirmation or error popups. |
| | When technical constraints exist, data previously entered into fields may not |
| | be shown when user navigates back to a page. However, actual |
| | implementations may differ based on the technical constraints. |
| Default | In general, the first item on a page is pre-selected (default item) unless the user |
| Selection | has performed some action, like viewing or renaming an image. |
| Misc. keys | If arrow buttons on the side of the phone are available they should scroll down |
| | an entire page in a list or thumbnail screen. |
| | Image names should appear bold/strong when displayed on an instructional |
| | screen, e.g. 2.1.4. Normal text should be used for lists of images. |
| | In this document any underlined item is a link. Actual presentation of links, |
| | whether underlined or other, is determined by the device. |

Soft key & Menu Labels

In a representative implementation, labels that may appear on a soft key are restricted to 7 characters. Menu-only items are restricted to 14 characters.

Common Labels

| | |
|---|---|
| OK | Performs the default action for a screen or for a selected item. |
| | Moves the user forward in a task. (e.g., opens an album or |
| | photo.) |
| Cancel | Used in addition to “Back” when an action was initiated |
| | and can be cancelled. Cancel usually performs same action as |
| | back, but is displayed to increase user confidence that |
| | the action was cancelled. |
| Edit | When possible, “Edit” links to a textbox editing screen. |
| Open | Opens a folder, message, file, etc. Should not be used for links |
| | not associated with files, folders, etc. |
| Back | “Back” label should be used only for the Back function |
| | described above. If possible, Back should always map |
| | only to the device back button. |
| Home | Links to the home screen of the MIDlet. |

Global Elements
Confirmation Popup

One type of global elements, presented as “Confirm Popup” screens, are used for displaying a confirmation to the user. The confirmation popup screens contain simple text such as “Done” or “Saved”, and they disappears automatically after a short time.

In Progress Screen

The “in progress” screen informs the user that the application is waiting for a response from the server or is processing a request. Each device has a default screen with text and a moving graphic, and, alternatively, it is replaced with a Yahoo! Canvas screen.

Screen Flows: Online Albums

As described above, the online album pages are made available to the user in forward and backwards traversal; each page having default selection items associated with it. The forward traversal starts, of course, with the home page (2.0). The following tables outline for each page separately the default selection items available in that page for screen flows.

2.0 J2ME Client Home

| Default | Mobile Album | | | | |
|---|---|---|---|---|---|
| Selection | | | | | |
| | | | Pref. | | |
| Actions | Label | Function | Location | Type | Priority |
| | | Left soft key opens | Primary | ITEM | 1 |
| | | selected page. | Soft key, | | |
| | | Numbers 1, 2, 3, 4 | OK Button | | |
| | | also open pages. | | | |

| | |
|---|---|
| Enter/OK | Open |
| Up Arrow | Select previous item |
| Down | Select next item |
| Arrow | |
| Left | Select next item |
| Arrow | |
| Right | Select previous item |
| Arrow | |
| Comments | Descriptive text and/or graphics will be added to this screen. |
| | Icons may be used in place of text links. |
| | “Sign Out” appears only when user is signed in. |

1.0 Sign In

| Default | ID Field. | | | | |
|---|---|---|---|---|---|
| Selection | | | | | |
| | | | Pref. | | |
| Actions | Label | Function | Location | Type | Priority |
| | Edit | Opens selected | Primary | EDIT | 1 |
| | | textbox for | Soft key, | | |
| | | editing | OK Button | | |
| | SignIn | Submits Form | Secondary | OK | 1 |
| | | | Soft key | | |
| | Back | 2.0 J2ME | Back | BACK | 1 |
| | | Client Home | button | | |

| | |
|---|---|
| Up Arrow | Jumps up. |
| Down | Jumps down. |
| Arrow | |
| Left Arrow | — |
| Right | — |
| Arrow | |
| Comments | Cache as much as legally & technically possible. |

2.1 My Online Albums

| Default | First Album, or last selected album in current session. | | | | |
|---|---|---|---|---|---|
| Selection | | | | | |
| Primary | Open. Same as Enter. | | | | |
| Soft key | | | | | |
| | | | Pref. | | |
| Actions | Label | Function | Location | Type | Priority |
| | Open | Opens selected | Primary | ITEM | 1 |
| | | album to last-used | Soft key, | | |
| | | view- 2.1.1 or | OK Button | | |
| | | 2.1.2. List is | | | |
| | | default. | | | |
| | | If album contains | | | |
| | | no images, opens | | | |
| | | 2.1.6 Photos List | | | |
| | | Empty. | | | |
| | Back | Previous screen. | Back | BACK | 1 |
| | | | button | | |

| | |
|---|---|
| Up Arrow | Jumps to previous item in list. If top item is selected, |
| | does nothing. |
| Down | Jumps to next item in list. If last item is selected, |
| Arrow | does nothing. |
| Left Arrow | — |
| Right | — |
| Arrow | |

2.1.1 Photos Thumbs

| Default | One thumbnail is always selected. Selection is indicated by 2 pixel black border. | | | | |
|---|---|---|---|---|---|
| Selection | When scrolling to a page either (1) or (4) is selected. | | | | |
| | When returning from a list view, full-screen view, or action screen the last selected | | | | |
| | image is selected. | | | | |
| | | | Pref. | | |
| Actions | Label | Function | Location | Type | Priority |
| | Open | Opens 2.1.3 Online Photo | Primary | ITEM | 1 |
| | | NOTE: pressing 1, 2, 3, or | Soft key, | | |
| | | 4 opens the photo | OK Button | | |
| | | currently in that position. | | | |
| | Add to | Saves image to mobile | Menu | ITEM | 2 |
| | Mobile | album and opens 2.1.7 | | | |
| | Album | Added to Mobile | | | |
| | Screen | Links to 2.1.4 Save as | Menu | ITEM | 3 |
| | Saver | Screensaver | | | |
| | Email | Links to 2.1.5 Share as | Menu | ITEM | 3 |
| | Photo | Email | | | |
| | Photo | Links to 2.1.2 Photo List | Menu | SCREEN | 1 |
| | List | | | | |
| | Online | Links to 2.1 My Online | Menu | SCREEN | 2 |
| | Albums | Albums | | | |
| | Home | Links to 2.0 J2ME Client | Menu | SCREEN | 3 |
| | | Home | | | |
| | Back | Previous screen | Back | BACK | 1 |
| | | | button | | |

| | |
|---|---|
| Up Arrow | When (3) or (4) is selected, jumps up to (1) or (2). |
| | When (1) or (2), moves up one row. |
| Down | When (1) or (2) is selected, jumps down to (3) or (4). |
| Arrow | When (3) or (4), moves down one row. |
| Left Arrow | Cycle through all thumbs on the screen, (4)-(1) then to the row above. Rows are added |
| | one at a time, so the top row shifts down when a new row is loaded. |
| Right | Cycle through all thumbs on the screen, (1)-(4) then to the row below. Rows are added |
| Arrow | one at a time, so the bottom row shifts up when a new row is loaded. |
| Comments | List loops back to beginning when user reaches last image. When looping to the |
| | beginning, the full screen refreshes with 2 rows of images. |
| | Each photo is surrounded by 2 pixels of white space. The selected photo has a 2 pixel |
| | black border. |

2.1.2 Photo List

| Default | One item is always selected. | | | | |
|---|---|---|---|---|---|
| Selection | When returning from a thumbnail view, full-screen view, or action | | | | |
| | screen the last selected image is selected. | | | | |
| | After deleting, the image in the spot that contained the deleted image is | | | | |
| | selected. | | | | |
| | | | Pref. | | |
| Actions | Label | Function | Location | Type | Priority |
| | Open | Opens 2.1.3 Online | Primary | ITEM | 1 |
| | | Photo | Soft key, | | |
| | | | OK | | |
| | | | Button | | |
| | Add to | Saves image to | Menu | ITEM | 2 |
| | Mobile | mobile album | | | |
| | Album | | | | |
| | Screen | Links to 2.1.4 Save | Menu | ITEM | 3 |
| | Saver | as Screensaver | | | |
| | Email | Links to 2.1.5 Share | Menu | ITEM | 3 |
| | Photo | as Email | | | |
| | Thumbnails | Links to 2.1.1 Photo | Menu | SCREEN | 1 |
| | | Thumbs | | | |
| | Online | Links to 2.1 My | Menu | SCREEN | 2 |
| | Albums | Online Albums | | | |
| | Home | Links to 2.0 J2ME | Menu | SCREEN | 3 |
| | | Client Home | | | |
| | Back | Previous screen | Back | BACK | 1 |
| | | | button | | |

| | |
|---|---|
| Up Arrow | Jumps to previous item in list. If top item is selected, does nothing. |
| Down | Jumps to next item in list. If last item is selected, does nothing. |
| Arrow | |
| Left Arrow | — |
| Right | — |
| Arrow | |
| Comments | File extensions are displayed. |
| | Items are displayed in order specified by the Yahoo! Photos system. |
| | User cannot rename, delete, or move photos. |

2.1.3 Online Photo

| Default | — | | | | |
|---|---|---|---|---|---|
| Selection | | | | | |
| | | | Pref. | | |
| Actions | Label | Function | Location | Type | Priority |
| | Done | Links to 2.1.1 | Primary | SREEN | 1 |
| | | or 2.1.2 | Soft key | | |
| | Add to | Saves image to | Menu | ITEM | 2 |
| | Mobile | mobile album | | | |
| | Album | | | | |
| | Screen | Links to 2.1.4 | Menu | ITEM | 3 |
| | Saver | Save as | | | |
| | | Screensaver | | | |
| | Email | Links to 2.1.5 | Menu | ITEM | 3 |
| | Photo | Share as Email | | | |
| | Online | Links to 2.1 | Menu | SCREEN | 2 |
| | Albums | My Online | | | |
| | | Albums | | | |
| | Home | Links to 2.0 | Menu | SCREEN | 3 |
| | | J2ME Client | | | |
| | | Home | | | |
| | Back | Previous screen | Back | BACK | 1 |
| | | | button | | |

| | |
|---|---|
| Up Arrow | — |
| Down Arrow | — |
| Left Arrow | Jumps to previous image in gallery. |
| Right Arrow | Jumps to next image in gallery. |
| Comments | Image should be as large as possible on any |
| | particular screen. |

2.1.4 Save as Screensaver

| Default | Text entry field | | | | |
|---|---|---|---|---|---|
| Selection | | | | | |
| | | | Pref. | | |
| Actions | Label | Function | Location | Type | Priority |
| | OK | Initiates PCS | Primary | SCREEN | 1 |
| | | Vision | Soft key, | | |
| | | download | OK | | |
| | | process. | Button | | |
| | Cancel | Cancels | Second | SCREEN | 2 |
| | | operation and | Soft key | | |
| | | returns to | | | |
| | | previous screen | | | |
| | Back | Previous screen | Back | BACK | 1 |
| | | | button | | |

| | |
|---|---|
| Up Arrow | — |
| Down Arrow | — |
| Left Arrow | |
| Right Arrow | |
| Comments | |

2.1.5 Share as Email

| Default | Text entry field | | | | |
|---|---|---|---|---|---|
| Selection | | | | | |
| | | | Pref. | | |
| Actions | Label | Function | Location | Type | Priority |
| | Send | Send. Sends | Secondary | ITEM | 1 |
| | | email to | Soft key | | |
| | | recipients and | | | |
| | | user with link | | | |
| | | to image | | | |
| | | on web. | | | |
| | | Confirmation | | | |
| | | pops up for a | | | |
| | | moment, then | | | |
| | | user is returned | | | |
| | | to 2.1.1, 2.1.2, | | | |
| | | or 2.1.3. | | | |
| | | If email address | | | |
| | | was not formed | | | |
| | | correctly an error | | | |
| | | appears. | | | |
| | Edit/ | Opens textbox for | Primary | | 1 |
| | Pick/ | editing, toggles | Soft key, | | |
| | OK | state of | OK | | |
| | | checkbox, or | Button | | |
| | | sends. | | | |
| | Back | Previous screen | Back | BACK | 1 |
| | | | button | | |

| | |
|---|---|
| Up Arrow | — |
| Down | — |
| Arrow | |
| Left Arrow | — |
| Right | — |
| Arrow | |
| Comments | |

2.1.6 Photo List Empty

Default
Selection

| | | | Pref. | | |
|---|---|---|---|---|---|
| Actions | Label | Function | Location | Type | Priority |
| | Back | 2.1 My Online | Back | BACK | 1 |
| | | Albums | button | | |

| | |
|---|---|
| Up Arrow | — |
| Down Arrow | — |
| Left Arrow | — |
| Right Arrow | — |
| Comments | Displayed for a moment, then automatically links back to |
| | 2.1 My Online Albums |

Screen Flows: Mobile Album

As with the online album, the mobile album pages are made available to the user in forward and backwards traversal; each page having default selection items associated with it. Here again, the forward traversal starts, of course, with the home page (2.0). The following tables outline for each page separately the default selection items available in that page for screen flows.

3.1.1 Mobile Photo List

| Default | One item is always selected. | | | | |
|---|---|---|---|---|---|
| Selection | When returning from a thumbnail view, full-screen view, or action | | | | |
| | screen the last selected image is selected. | | | | |
| | After deleting, the image in the spot that contained the deleted image is | | | | |
| | selected. | | | | |
| | | | Pref. | | |
| Actions | Label | Function | Location | Type | Priority |
| | Open | Opens selected photo | Primary | ITEM | 1 |
| | | in 3.1.3 Mobile | Soft key, | | |
| | | Photo | OK | | |
| | | | Button | | |
| | Slideshow | Links to 3.3 Mobile | Menu | ITEM | 2 |
| | | Slideshow, starting | | | |
| | | show with current | | | |
| | | photo | | | |
| | Move | Links to 3.2.1 Move | Menu | ITEM | 4 |
| | Delete | Links to 3.2.4 Delete | Menu | ITEM | 4 |
| | Thumbnails | Links to 3.1.1 | Menu | SCREEN | 1 |
| | | Mobile- Photo | | | |
| | | Thumbs | | | |
| | Home | Links to 2.0 J2ME | Menu | SCREEN | 2 |
| | | Client Home | | | |
| | Back | Previous screen | Back | BACK | 1 |
| | | | button | | |

| | |
|---|---|
| Up Arrow | Jumps to previous item in list. If top item is selected, does nothing. |
| Down | Jumps to previous item in list. If last item is selected, does nothing. |
| Arrow | |
| Left Arrow | — |
| Right | — |
| Arrow | |
| Comments | File extensions are not displayed. |

3.1.2 Mobile Photo Thumbs

| Default | One thumbnail is always selected. Selection is indicated by 2 pixel | | | | |
|---|---|---|---|---|---|
| Selection | border. | | | | |
| | When returning from a list view, full-screen view, or action screen the | | | | |
| | last selected image is selected. | | | | |
| | After deleting, the image in the spot that contained the deleted image is | | | | |
| | selected. | | | | |
| | After Moving, the last moved image is selected. | | | | |
| | | | Pref. | | |
| Actions | Label | Function | Location | Type | Priority |
| | Open | Opens 3.1.3 Mobile | Primary | ITEM | 1 |
| | | Photo | Soft key, | | |
| | | NOTE: pressing | OK | | |
| | | 1, 2, 3, or 4 opens the | Button | | |
| | | photo currently in | | | |
| | | that position. | | | |
| | Slideshow | Links to 3.3 Mobile | Menu | ITEM | 2 |
| | | Slideshow, starting | | | |
| | | show with current | | | |
| | | photo | | | |
| | Move | Links to 3.2.1 Move | Menu | ITEM | 4 |
| | Delete | Links to 3.2.4 Delete | Menu | ITEM | 4 |
| | Photo List | Links to 3.1.1 | Menu | SCREEN | 1 |
| | | Mobile—Photo List | | | |
| | Home | Links to 2.0 J2ME | Menu | SCREEN | 2 |
| | | Client Home | | | |
| | Back | Previous screen | Back | BACK | 1 |
| | | | button | | |

| | |
|---|---|
| Up Arrow | When (3) or (4) is selected, jumps up to (1) or (2). |
| | When (1) or (2), moves up one row. |
| Down | When (1) or (2) is selected, jumps down to (3) or (4). |
| Arrow | When (3) or (4), moves down one row. |
| Left Arrow | Cycle through all thumbs on the screen, (4)-(1) then to the row above. |
| | Rows are added one at a time, so the top row shifts down when a new |
| | row is loaded. |
| Right | Cycle through all thumbs on the screen, (1)-(4) then to the row below. |
| Arrow | Rows are added one at a time, so the bottom row shifts up when a new |
| | row is loaded. |
| Comments | List loops back to beginning when user reaches last image. When |
| | looping to the beginning, the full screen refreshes all 4 images. |
| | When an image is deleted all other images move to fill the empty space |
| | Each photo is surrounded by 2 pixels of white space. The selected photo |
| | has a 2 pixel border. |

3.1.3 Mobile Photo

| Default | — | | | | |
|---|---|---|---|---|---|
| Selection | | | | | |
| | | | Pref. | | |
| Actions | Label | Function | Location | Type | Priority |
| | Done | Album. Links | Primary | ITEM | 1 |
| | | to most recent | Soft key, | | |
| | | view of | OK | | |
| | | album - 3.1.1 | Button | | |
| | | or 3.1.2 - | | | |
| | | with most | | | |
| | | recently viewed | | | |
| | | image | | | |
| | | selected. | | | |
| | Slideshow | Links to 3.3 | Menu | ITEM | 2 |
| | | Mobile | | | |
| | | Slideshow, | | | |
| | | starting show | | | |
| | | with current | | | |
| | | photo | | | |
| | Move | Links to 3.2.1 | Menu | ITEM | 4 |
| | | Move | | | |
| | Delete | Links to 3.2.4 | Menu | ITEM | 4 |
| | | Delete | | | |
| | Home | Links to 2.0 | Menu | SCREEN | 2 |
| | | J2ME Client | | | |
| | | Home | | | |
| | Back | Previous screen | Back | BACK | 1 |
| | | | button | | |

| | |
|---|---|
| Up Arrow | — |
| Down | — |
| Arrow | |
| Left | Jumps to previous image in gallery. When first image is |
| Arrow | reached, loops to end. |
| Right | Jumps to next image in gallery. When last image is |
| Arrow | reached, loops to beginning. |
| Comments | Image should be as large as possible on any particular screen. |

3.1.4 Mobile Album Empty

| Default | My Online Albums | | | | |
|---|---|---|---|---|---|
| Selection | | | | | |
| | | | Pref. | | |
| Actions | Label | Function | Location | Type | Priority |
| | OK | | Primary | ITEM | 1 |
| | | | Soft key, | | |
| | | | OK Button | | |
| | Back | Previous screen | Back | BACK | 1 |
| | | | button | | |

| | |
|---|---|
| Up Arrow | — |
| Down | — |
| Arrow | |
| Left Arrow | — |
| Right | — |
| Arrow | |
| Comments | |

3.1.4.1. Mobile- About

| Default | My Online Albums | | | | |
|---|---|---|---|---|---|
| Selection | | | | | |
| | | | Pref. | | |
| Actions | Label | Function | Location | Type | Priority |
| | OK | Links to 2.1 My | Primary | ITEM | 1 |
| | | Online Albums | Soft key, | | |
| | | | OK Button | | |
| | Back | Previous screen | Back | BACK | 1 |
| | | | button | | |

| | |
|---|---|
| Up Arrow | — |
| Down | — |
| Arrow | |
| Left Arrow | — |
| Right | — |
| Arrow | |
| Comments | |

3.1.4.2 Mobile- Restore Album Info

| Default | My Online Albums | | | | |
|---|---|---|---|---|---|
| Selection | | | | | |
| | | | Pref. | | |
| Actions | Label | Function | Location | Type | Priority |
| | OK | Links to 3.1.4.2.1 | Primary | ITEM | 1 |
| | | Restore Mobile | Soft key, | | |
| | | Album | OK Button | | |
| | Back | Previous screen | Back | BACK | 1 |
| | | | button | | |

| | |
|---|---|
| Up Arrow | — |
| Down | — |
| Arrow | |
| Left Arrow | — |
| Right | — |
| Arrow | |
| Comments | |

3.1.4.2.1 Restore Mobile Album

Default
Selection

| | | | Pref. | | |
|---|---|---|---|---|---|
| Actions | Label | Function | Location | Type | Priority |
| | Pick | Toggles state of | Primary | ITEM | 1 |
| | | checkbox | Soft key, | | |
| | | | OK Button | | |
| | Save | Downloads all | Secondary | SCREEN | 1 |
| | | selected images to | Soft key | | |
| | | Mobile Album | | | |
| | Back | Previous screen | Back | BACK | 1 |
| | | | button | | |

| | |
|---|---|
| Up Arrow | Jumps to previous item in list. If top item is selected, |
| | does nothing. |
| Down | Jumps to next item in list. If last item is selected, does |
| Arrow | nothing. |
| Left | May toggle state of checkbox. |
| Arrow | |
| Right | May toggle state of checkbox. |
| Arrow | |
| Comments | This screen lists a close approximation of the items |
| | downloaded to a particular phone using a particular account. |
| | When the user has selected the photos he wishes to restore |
| | and presses “Save” all the images are downloaded |
| | to the mobile album. If the Mobile Album already has |
| | photos in it, restored are added at the bottom of the list. |

3.2.1 Move

| Default | Selected Photo | | | | |
|---|---|---|---|---|---|
| Selection | | | | | |
| | | | Pref. | | |
| Actions | Label | Function | Location | Type | Priority |
| | Done | Drops photo in | Primary | OK | 1 |
| | | current location. | Soft key, | | |
| | | Links to 3.2.1 | OK Button | | |
| | | with moved photo | | | |
| | | selected. | | | |
| | Back | Links to previous | Back | BACK | 1 |
| | | page (before | button | | |
| | | move command | | | |
| | | was selected) | | | |
| | | and cancels | | | |
| | | move. | | | |

| | |
|---|---|
| Up Arrow | When (3) or (4) is selected, swaps with (1) or (2). |
| | When (1) or (2) is selected, moves up one row. |
| Down | When (1) or (2) is selected, swaps with (3) or (4). |
| Arrow | When (3) or (4) is selected, moves down one row. |
| Left Arrow | When (1) is selected, jumps to previous screen |
| | and swaps with (4) on that screen. |
| | When (2) is selected, swaps with (1). |
| | When (3) is selected, swaps with (2). |
| | When (4) is selected, swaps with (3). |
| | When first image is selected, jumps to last image. |
| Right | When (4) is selected, jumps to previous screen and |
| Arrow | swaps with (1) on that screen. |
| | When (3) is selected, swaps with (2). |
| | When (2) is selected, swaps with (3). |
| | When (3) is selected, swaps with (4). |
| | When final image is selected, jumps to first image. |
| Comments | Small arrow images overlaid on the image being moved. |

3.2.4 Delete

| Default | — | | | | |
|---|---|---|---|---|---|
| Selection | | | | | |
| | | | Pref. | | |
| Actions | Label | Function | Location | Type | Priority |
| | Delete | Deletes photo and | Primary | OK | 1 |
| | | returns user to | Soft key | | |
| | | 3.1.1 or 3.1.2 | | | |
| | | (last used) with | | | |
| | | image in position | | | |
| | | of deleted image | | | |
| | | selected. | | | |
| | Cancel | Cancels deletion | Secondary | BACK | 2 |
| | | and links to | Soft key | | |
| | | previous screen | | | |
| | Back | Cancels deletion | Back | BACK | 1 |
| | | and links to | button | | |
| | | previous screen | | | |

| | |
|---|---|
| Up Arrow | — |
| Down | — |
| Arrow | |
| Left Arrow | — |
| Right | — |
| Arrow | |
| Comments | |

3.2.4 Delete All

Default
Selection

| | | | Pref. | | |
|---|---|---|---|---|---|
| Actions | Label | Function | Location | Type | Priority |
| | Delete | Deletes all photos | Primary | OK | 1 |
| | | and returns user | Soft key | | |
| | | to 3.1.4 Mobile | | | |
| | | Album Empty. | | | |
| | Cancel | Cancels deletion | Secondary | BACK | 2 |
| | | and links to | Soft key | | |
| | | previous screen | | | |
| | Back | Cancels deletion | Back | BACK | 1 |
| | | and links to | button | | |
| | | previous screen | | | |

| | |
|---|---|
| Up Arrow | — |
| Down | — |
| Arrow | |
| Left Arrow | — |
| Right | — |
| Arrow | |
| Comments | |

3.3 Mobile Slideshow

Default
Selection

| | | | Pref. | | |
|---|---|---|---|---|---|
| Actions | Label | Function | Location | Type | Priority |
| | Stop | Ends slideshow | Primary | OK | 1 |
| | | and returns user | Soft key | | |
| | | to 3.1.1 or 3.1.2 | | | |
| | | (last used). | | | |
| | Pause | Pauses slideshow | Menu | SCREEN | 1 |
| | | and switches first | | | |
| | | Action to “Play.” | | | |
| | | Pressing again | | | |
| | | re-starts | | | |
| | | slideshow | | | |
| | | from the current | | | |
| | | image. | | | |
| | Slow | Switches speed to | Menu | SCREEN | 2 |
| | | Slow. | | | |
| | Normal | Switches speed to | Menu | SCREEN | 3 |
| | | Normal. | | | |
| | Fast | Switches speed to | Menu | SCREEN | 4 |
| | | Fast | | | |

| | |
|---|---|
| Up Arrow | — |
| Down | — |
| Arrow | |
| Left | Jumps to previous image. Slideshow continues to play |
| Arrow | at same speed. |
| Right | Jumps to next image. Slideshow continues to play at |
| Arrow | same speed. |
| Comments | Image should be as large as possible on any particular screen. |
| | If possible, backlight should remain on until slideshow is |
| | stopped. |
| | Screen should not refresh while Actions menu is open. |
| | The screen has no header. |

Although the present invention has been described in accordance with the embodiments shown, variations to the embodiments would be apparent to those skilled in the art and those variations would be within the scope and spirit of the present invention. Accordingly, it is in tended that the specification and embodiments shown be considered exemplary only, with a true scope of the invention being indicated by the following claims and equivalents.

1. A method for moving an image in a mobile device, comprising:
maintaining place holders in memory of a mobile device with a screen, each of the place holders being associated with a location on the screen;
attributing indicia to the image;
assigning the indicia of the image to one of the place holders;
maintaining a selected holder in the memory;
selecting the image;
saving in the selected holder the screen location associated with the place holder to which indicia of the selected image is assigned; and
to move the selected image, reassigning the indicia of the selected image to a different one of the place holders and replacing in the selected holder the saved screen location associated with the place holder with the screen location associated with the different place holder, wherein memory bandwidth consumption is lower with the use of the place holders and the selected holder than it would be with only movement of the selected image.

2. The method of claim 1, wherein the movement is made by activating a navigation key.

3. The method of claim 1, wherein an image is selected by activating a button.

4. The method of claim 3, wherein the image is selected in response to an indication of acceptance or acknowledgement from the button.

5. The method of claim 1, further comprising, in response to a final move indication, fixing the screen location of the selected image.

6. The method of claim 1, further comprising producing a final move indication for the selected image.

7. The method of claim 6, wherein the final move indication is produced by activating an OK button.

8. The method of claim 5, wherein there is an image in more than one of the screen locations, and wherein after fixing the location of the selected image, any one of the images on the screen is selectable and one of the images is newly selected.

9. The method of claim 8, wherein the steps of saving in the selected holder and moving are performed for the newly selected image.

10. The method of claim 1, wherein there is an image in more than one of the screen locations, and wherein the images are rearranged on the screen each time the selected image is moved.

11. The method of claim 1, wherein the mobile device is a wireless device.

12. The method of claim 1, wherein the place holders are location indices.

13. The method as in claim 1, wherein the indicia attributed to each of the images is an image index.

14. The method of claim 1, wherein the mobile device is a wireless camera phone and the image is a photo.

15. A system in a mobile devices for moving an image on a screen of the mobile device, comprising:
a processor; and
memory embodying place holders and a selected holder, the memory further embodying
a computer program with program code for causing the processor to perform the steps of:
associating each of the place holders with a location on the screen;
attributing indicia to the image;
assigning the indicia of the image to one of the place holders;
selecting the image;
saving in the selected holder the screen location associated with the place holder to which indicia of the selected image is assigned; and
to move the selected image, reassigning the indicia of the selected image to a different one of the place holders and replacing in the selected holder the saved screen location associated with the place holder with the screen location associated with the different place holder,
wherein memory bandwidth consumption is lower with the use of the place holders and the selected holder than it would be with only movement of the selected image.

16. The system of claim 15, wherein the system includes a navigation key with up-down-left-right buttons linked with the processor to indicate image movement commands.

17. The system of claim 15, wherein the navigation key includes an acceptance or acknowledgement button linked with the processor to indicate image selection or accept final location commands.

18. The system of claim 15, wherein there is an image in more than one of the screen locations, and wherein the computer program in the memory includes further program code to cause the processor to perform the further step of, after fixing the screen location of the selected image such that any one of the images on the screen is selectable, again selecting an image.

19. The system of claim 18, wherein the steps of saving in the selected holder and moving the image are performed for a newly selected image.

20. The system of claim 15, wherein there is an image in more than one of the screen locations, and wherein the computer program in the memory includes further program code to cause the processor to rearrange the images on the screen each time the selected image is moved.

21. The system of claim 15, wherein the mobile device is a wireless device.

22. The system of claim 15, wherein the place holders are location indices.

23. The system as in claim 15, wherein the indicia attributed to each of the images is an image index.

24. The system of claim 15, wherein the mobile device is a wireless camera phone and the image is a photo.
